(19) United States
(12) Patent Application Publication
(10) Pub. No.: US 2025/0196493 A1
(43) Pub. Date: Jun. 19, 2025

(54) INKJET RECORDING APPARATUS

(71) Applicant: KYOCERA Document Solutions Inc., Osaka (JP)

(72) Inventor: Masaaki Nishihara, Osaka (JP)

(21) Appl. No.: 18/981,292

(22) Filed: Dec. 13, 2024

(30) Foreign Application Priority Data
Dec. 14, 2023 (JP) 2023-211055

(51) Int. Cl. B41J 2/045; B41J 29/377

(52) U.S. Cl. CPC B41J 2/04531; B41J 2/04553; B41J 2/04563; B41J 2/04581; B41J 29/377

(57) ABSTRACT

A nozzle unit has a first heater, a first temperature sensor, and a drive circuit. The second heater heats the nozzle unit from outside. A second temperature sensor detects a temperature outside the nozzle unit. A control portion adjusts power supplied to the first heater by a first temperature feedback control. The control portion operates the cooling device when a temperature detected by the first temperature sensor exceeds an allowable temperature while the first temperature feedback control is being executed. The control portion stops the supply of power to the first heater and the drive circuit when a pause condition is met. The control portion adjusts the power supplied to the second heater 52 by a second temperature feedback control in a paused state.

### INCORPORATION BY REFERENCE

This application is based upon and claims the benefit of priority from the corresponding Japanese Patent Application No. 2023-211055 filed on Dec. 14, 2023, the entire contents of which are incorporated herein by reference.

### BACKGROUND

The present disclosure relates to an inkjet recording apparatus capable of heating and cooling a nozzle unit.

The inkjet recording apparatus includes a nozzle unit including a plurality of piezoelectric elements and a plurality of nozzles. When a drive signal is supplied to each of the piezoelectric elements, the piezoelectric elements pressurize ink with energy corresponding to the drive signal. The piezoelectric elements pressurize the ink in response to the drive signal, causing the nozzles to eject ink.

It is known that the nozzle unit includes a heater and a temperature sensor. The power supplied to the heater is adjusted by feedback control based on the temperature detected by the temperature sensor.

### SUMMARY

An inkjet recording apparatus according to one aspect of the present disclosure includes: a nozzle unit having a plurality of nozzles, a plurality of piezoelectric elements, a first heater, and a first temperature sensor; a second heater; a cooling device; a second temperature sensor; and a control portion. The plurality of piezoelectric elements correspond to the plurality of nozzles. The drive circuit is capable of supplying a drive signal to the plurality of piezoelectric elements. The nozzle unit forms an image on a sheet by ink ejected from the plurality of nozzles by supplying the drive signal to the plurality of piezoelectric elements. The second heater heats the nozzle unit from outside. The cooling device cools the nozzle unit with a coolant. The second temperature sensor detects a temperature outside the nozzle unit. The control portion controls the first heater, the drive circuit, the second heater, and the cooling device. The control portion adjusts the power supplied to the first heater by a first temperature feedback control based on a first detected temperature detected by the first temperature sensor and a first target temperature. The control portion further operates the cooling device when the first detected temperature exceeds an allowable temperature under a condition in which the first temperature feedback control is being executed. The control portion further stops the supply of power to the first heater and the drive circuit when a pause condition including a state in which an image formation request is not received is satisfied under a situation in which the first temperature feedback control is being executed. The control portion further adjusts the power supplied to the second heater by a second temperature feedback control based on a second detected temperature detected by the second temperature sensor and a second target temperature in a paused state in which power supply to the first heater and the drive circuit is stopped. In a case in which the control portion receives the image formation request in the paused state, the control portion further adjusts the power supplied to the first heater by the first temperature feedback control.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to an embodiment.

FIG. 2 is a cross-sectional view of a nozzle unit in an inkjet recording apparatus according to an embodiment.

FIG. 3 is a block diagram showing a configuration of a control device in an inkjet recording apparatus according to an embodiment.

FIG. 4 is a flowchart showing an example of a procedure for controlling apparatus temperature in an inkjet recording apparatus according to an embodiment.

FIG. 5 is a flowchart showing an example of a procedure for a request response process in an inkjet recording apparatus according to an embodiment.

FIG. 6 is a flowchart showing an example of a procedure for a post-permission process in an inkjet recording apparatus according to an embodiment.

FIG. 7 is a flowchart showing an example of a procedure for a post-printing process in an inkjet recording apparatus according to an embodiment.

### DETAILED DESCRIPTION

Hereinafter, an embodiment according to the present disclosure will be described with reference to the drawings. Note that the following embodiment is an example according to the present disclosure and does not limit the technical scope according to the present disclosure.

### Configuration of Inkjet Recording Apparatus 10

The inkjet recording apparatus 10 according to an embodiment is a printer capable of performing a printing process by an inkjet method.

The printing process is a process for forming an image on a sheet 9. The sheet 9 is a sheet-like image forming medium such as paper or a resin film.

Note that the inkjet recording apparatus 10 may be a facsimile apparatus, a copier, a multifunction peripheral, or the like that is capable of executing the printing process by an inkjet method.

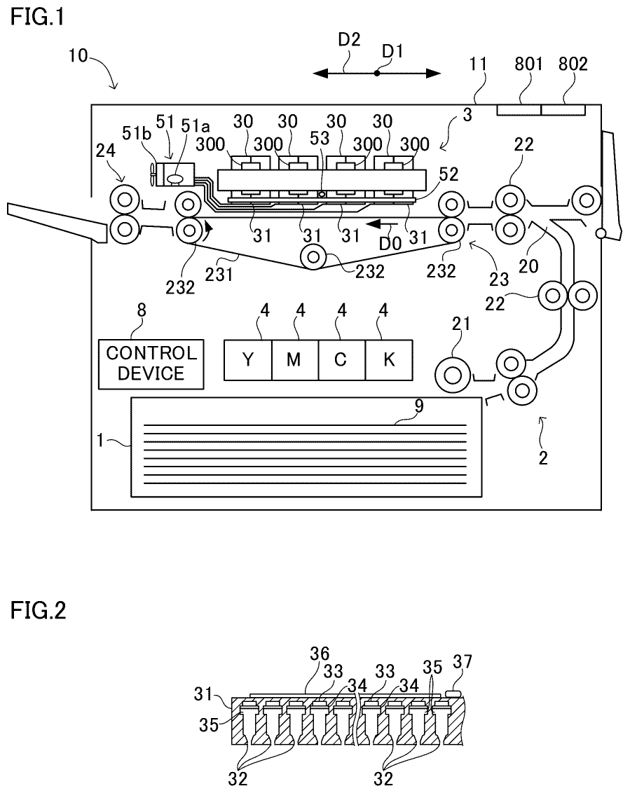

As shown in FIG. 1, an inkjet recording apparatus 10 includes a sheet storing portion 1, a sheet conveying device 2, a printing portion 3, a plurality of ink supply portions 4, a control device 8, and the like.

The sheet storing portion 1, the sheet conveying device 2, the printing portion 3, the plurality of ink supply portions 4 and the control device 8 are arranged within a main housing 11. Furthermore, the image forming apparatus 10 includes an operation device 801 and a display device 802.

The sheet conveying device 2 feeds out sheets 9 stored in the sheet storing portion 1 one by one to a conveying path 20, and further conveys the sheets 9 along the conveying path 20.

The sheet conveying device 2 includes a feeding mechanism 21, a plurality of conveying roller pairs 22, a belt conveying mechanism 23, a discharge roller pair 24, and the like. The feeding mechanism 21 feeds the sheet 9 from the sheet storing portion 1 to the conveying path 20. The plurality of conveying roller pairs 22 convey the sheet 9 along the conveying path 20, and further convey the sheet 9 to the belt conveying mechanism 23.

The belt conveying mechanism 23 is arranged below the printing portion 3. The belt conveying mechanism 23 includes a conveying belt 231 and a plurality of tension rollers 232.

The plurality of tension rollers 232 rotatably support the conveying belt 231. A motor (not shown) rotates one of the plurality of tension rollers 232 to rotate the conveying belt 231. The conveying belt 231 rotates to convey the sheet 9 on an upper surface of the conveying belt 231 in the conveying direction D0.

A direction perpendicular to the conveying direction D0 is a main scanning direction D1, and a direction along the conveying direction D0 is a sub-scanning direction D2 (see FIG. 1).

The printing portion 3 forms an image on the sheet 9 by ejecting ink of a plurality of colors onto the sheet 9 that is being conveyed by the belt conveying mechanism 23.

The discharge roller pair 24 is arranged farther on a downstream side in the conveying direction D0 than the belt conveying mechanism 23. The discharge roller pair 24 discharges the sheet 9 on which the image has been formed to the outside of the main housing 11. For example, the discharge roller pair 24 feeds the sheet 9 from the main housing 11 to a discharge tray or a downstream device arranged next to the inkjet recording apparatus 10.

Each of the plurality of ink supply portions 4 supplies ink of a predetermined color to the printing portion 3. For example, the ink colors are black, cyan, magenta and yellow. In this case, the inkjet recording apparatus 10 includes four ink supply portions 4.

### Printing Portion 3

The printing portion 3 forms an image on the sheet 9 by ejecting ink onto the sheet 9 that is conveyed by the belt conveying mechanism 23. The printing portion 3 includes a plurality of nozzle units 30 corresponding to a plurality of ink colors.

The printing portion 3 includes a plurality of nozzle units 30 corresponding to a plurality of ink colors. The plurality of ink supply portions 4 supply ink to the plurality of nozzle units 30.

In the present embodiment, the printing portion 3 includes four nozzle units 30 corresponding to black, cyan, magenta and yellow inks.

Each of the nozzle units 30 has an ink ejection portion 31. The ink ejection portion 31 is arranged opposite the upper surface of the conveying belt 231.

The ink ejection portion 31 includes a plurality of nozzles 32 (see FIG. 2). An image is formed on the sheet 9 by ejecting ink from each of the plurality of nozzles 32 onto the sheet 9.

Furthermore, the ink ejection portion 31 includes a plurality of piezoelectric elements 33, a plurality of pressure chambers 35, and a plurality of vibration plates 34. The plurality of piezoelectric elements 33, the plurality of pressure chambers 35 and the plurality of vibration plates 34 are provided corresponding to the plurality of nozzles 32, respectively.

The plurality of pressure chambers 35 are respectively connected to the plurality of nozzles 32. The plurality of pressure chambers 35 each form a passage for ink to be supplied to the plurality of nozzles 32. The ink in the plurality of pressure chambers 35 is supplied to the plurality of nozzles 32, respectively.

The plurality of vibration plates 34 each form a part of a partition wall of the plurality of pressure chambers 35. By supplying a drive signal to each of the piezoelectric elements 33, the piezoelectric elements 33 pressurize the ink in the pressure chambers 35 via the corresponding vibration plates 34.

The drive signal is a signal whose waveform is adjusted according to the size of ink droplets to be ejected. The drive signal is supplied from the control device 8 to each of the piezoelectric elements 33.

That is, when the drive signal is supplied from the control device 8 to each of the piezoelectric elements 33, the piezoelectric elements 33 pressurize the ink supplied to each of the plurality of nozzles 32.

The piezoelectric element 33 to which the drive signal is supplied vibrates with energy that causes ink to be ejected from the corresponding nozzle 32. That is, when the drive signal is supplied to each of the piezoelectric elements 33, the piezoelectric elements 33 pressurize the ink in the pressure chambers 35 to such an extent that the ink is ejected from the nozzles 32.

The ink pressurized by the piezoelectric element 33 to which the drive signal is supplied flows from the pressure chamber 35 into the corresponding nozzle 32 and is then ejected from the nozzle 32.

Each nozzle unit 30 further includes a unit heater 36 and a unit temperature sensor 37 (see FIG. 2). The unit heater 36 and the unit temperature sensor 37 is arranged in the ink ejection portion 31 of each nozzle unit 30.

That is, the inkjet recording apparatus 10 includes a plurality of unit heaters 36 and a plurality of unit temperature sensors 37 corresponding to the plurality of nozzle units 30.

The unit heater 36 heats the ink ejection portion 31. The unit temperature sensor 37 detects the temperature of the ink ejection portion 31. That is, the unit temperature sensor 37 detects the temperature of the nozzle unit 30 on the nozzle unit 30. For example, the unit temperature sensor 37 is a thermistor.

As the temperature of the ink decreases, the viscosity of the ink increases. In a case in which the viscosity of the ink supplied to each of the nozzles 32 is high, the ejection performance of the ink from each of the nozzles 32 deteriorates when each of the piezoelectric elements 33 operates.

The unit heater 36 heats the ink in the ink ejection portion 31 to maintain the viscosity of the ink supplied to each nozzle 32 at an appropriate state.

Before the printing process is started, the unit heater 36 heats the ink in the ink ejection portion 31, thereby shortening a first printing time. The first printing time is a time from when the inkjet recording apparatus 10 receives a printing request until when the inkjet recording apparatus 10 starts the printing process.

The power supplied to the unit heater 36 is adjusted by feedback control based on the temperature detected by the unit temperature sensor 37.

The operation device 801 receives human operations. For example, the operation device 801 includes one or both of a touch panel and one or more operation buttons. The display device 802 is capable of displaying various types of information. For example, the display device 802 is a panel display device such as a liquid crystal panel unit.

### Control Device 8

The control device 8 executes various types of data processing and controls the devices included in the inkjet recording apparatus 10.

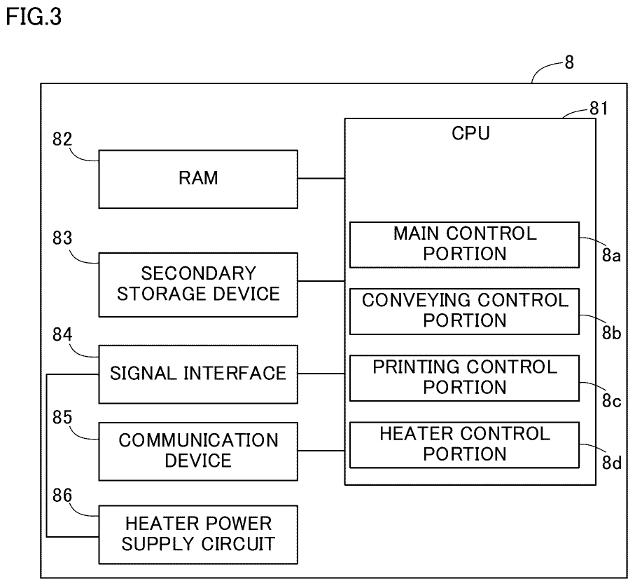

As shown in FIG. 3, the control device 8 includes a central processing unit (CPU) 81 and peripheral devices such as a random access memory (RAM) 82, a secondary storage device 83, and a signal interface 84. Furthermore, the control device 8 includes a communication device 85 and a heater power supply circuit 86.

The CPU 81 is a processor that executes various types of data processing and controls by executing computer programs. The CPU 81 is an example of a processor that controls the plurality of piezoelectric elements 33 and other devices.

The RAM 82 is a computer-readable volatile storage device. The RAM 82 temporarily stores the computer programs executed by the CPU 81 and data output and referenced by the CPU 81 in the course of executing various types of processing.

The secondary storage device 83 is a non-volatile storage device readable by a computer. The secondary storage device 83 is capable of storing and updating the computer programs and various types of data. For example, a flash memory or a hard disk drive, or both, may be employed as the secondary storage device 83.

The signal interface 84 converts signals output by various types of sensors into digital data, and transmits the converted digital data to the CPU 81. Furthermore, the signal interface 84 converts the control command output by the CPU 81 into a control signal, and transmits the control signal to a device to be controlled.

The communication device 85 is capable of communicating with a host device and other devices (not shown). The host device is an information processing apparatus such as a personal computer or a smartphone operated by a user.

For example, the CPU 81 receives a printing job from the host device via the communication device 85. The printing portion 3 forms an image specified by the printing job on the sheet 9.

The heater power supply circuit 86 supplies the unit heater 36 with power in an amount corresponding to an input unit power command.

The CPU 81 includes a plurality of processing modules that are achieved by executing the computer programs. The plurality of processing modules include a main control portion 8a, a conveying control portion 8b, a printing control portion 8c, and a temperature control portion 8d.

The main control portion 8a executes control to start various types of processes in response to a processing request inputted via the operation device 801 or the communication device 85, and controls a display device 802, or the like.

The conveying control portion 8b controls the sheet conveying device 2. That is, the conveying control portion 8b controls the supply of the sheet 9 by the feeding mechanism 21, the conveyance of the sheet 9 by the plurality of conveying roller pairs 22 and the belt conveying mechanism 23, and the discharge of the sheet 9 by the discharge roller pair 24.

The printing control portion 8c causes the printing portion 3 to execute the printing process in synchronization with the conveyance of the sheet 9 by the sheet conveying device 2. The printing control portion 8c controls the plurality of piezoelectric elements 33 to cause the printing portion 3 to execute the printing process.

The temperature control portion 8d controls the power supplied to the unit heater 36 by outputting the unit power command signal to the heater power supply circuit 86 via the signal interface 84.

Each nozzle unit 30 includes a drive circuit 300 that supplies the drive signal to each piezoelectric element 33 (see FIG. 1).

The drive circuit 300 outputs the drive signal to each of the piezoelectric elements 33 in accordance with the input pressure command signal. Each nozzle unit 30 forms an image on the sheet 9 with ink ejected from the plurality of nozzles 32 by supplying the drive signals from the drive circuit 300 to the plurality of piezoelectric elements 33.

The printing control portion 8c outputs the pressure command signal corresponding to the size of the ink droplets to be ejected from each nozzle 32 to the drive circuit 300 via the signal interface 84. The printing control portion 8c controls each of the piezoelectric elements 33 via the drive circuit 300.

The drive circuit 300 generates heat as a state in which the drive signal is output continues. As the drive circuit 300 generates heat, the temperature of each nozzle unit 30 increases.

When the inkjet recording apparatus 10 is executing continuous printing processes, it is necessary to suppress an excessive rise in temperature of each nozzle unit 30 due to heat generation by the drive circuit 300. For this reason, the inkjet recording apparatus 10 is provided with a cooling device 51 (see FIG. 1).

The cooling device 51 cools each of the nozzle units 30 with a coolant. For example, the coolant is water. The cooling device 51 includes a pump 51a that circulates the coolant, and a radiator 51b that radiates heat from the coolant (see FIG. 1). The pump 51a circulates the coolant through a circulation path that passes through each of the nozzle units 30 and the radiator 51b.

On the other hand, it is required to reduce power consumption of each of the nozzle units 30 and the cooling device 51 while shortening the first printing time.

The inkjet recording apparatus 10 has a configuration for reducing the first printing time while suppressing the power consumption of each of the nozzle units 30 and the cooling device 51. That configuration will be described below.

The inkjet recording apparatus 10 further includes a peripheral heater 52 and a peripheral temperature sensor 53 (see FIG. 1). The inkjet recording apparatus 10 includes one peripheral heater 52 and one peripheral temperature sensor 53 corresponding to the plurality of nozzle units 30.

The peripheral heater 52 heats around the plurality of nozzle units 30. The peripheral temperature sensor 53 detects the temperature around the plurality of nozzle units 30. For example, the peripheral temperature sensor 53 is a thermistor.

The unit heater 36 is an example of a first heater that heats the ink ejection portion 31 of each nozzle unit 30. The peripheral heater 52 is an example of a second heater that heats the plurality of nozzle units 30 from the outside.

The unit temperature sensor 37 is an example of a first temperature sensor that detects the temperature of each nozzle unit 30. The peripheral temperature sensor 53 is an example of a second temperature sensor that detects the temperature outside the plurality of nozzle units 30.

The heater power supply circuit 86 supplies the peripheral heater 52 with power in an amount according to an input peripheral power command. The temperature control portion 8d controls the power supplied to the peripheral heater 52 by outputting the peripheral power command signal to the heater power supply circuit 86 via the signal interface 84.

The temperature control portion 8d controls the power supplied to each of the unit heater 36 and the peripheral heater 52, and also controls the cooling device 51. Furthermore, the temperature control portion 8d controls the supply of power to and stopping the supply of power to the drive circuit 300.

In the following description, the temperature detected by the unit temperature sensor 37 is referred to as a first detected temperature, and the temperature detected by the peripheral temperature sensor 53 is referred to as a second detected temperature.

The temperature control portion 8d adjusts the power supplied to the unit heater 36 by a first temperature feedback control based on the first detected temperature and a first target temperature.

Furthermore, the temperature control portion 8d adjusts the power supplied to the peripheral heater 52 by a second temperature feedback control based on the second detected temperature and a second target temperature.

### Apparatus Temperature Control

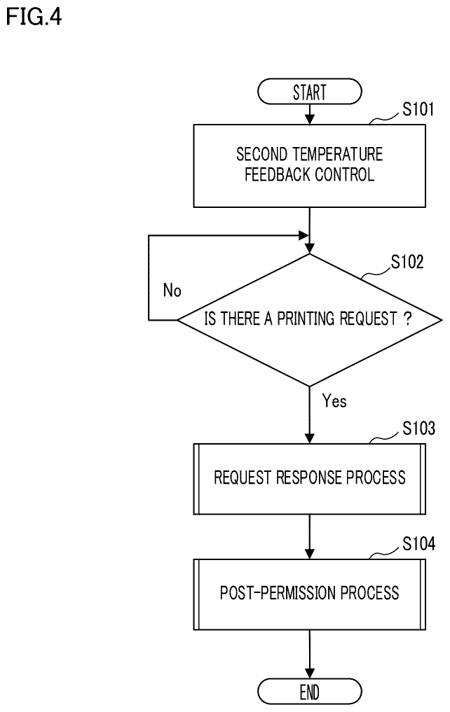

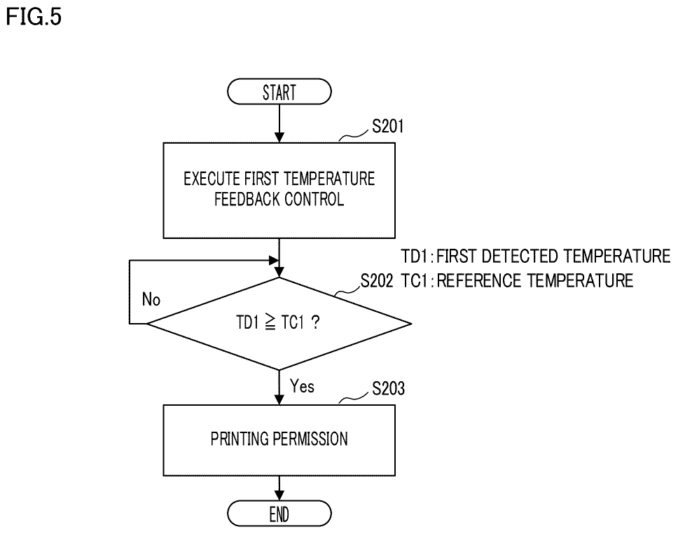

Hereinafter, an example of a procedure for performing apparatus temperature control by the temperature control portion 8d will be described with reference to the flowchart shown in FIG. 4.

The temperature control portion 8d starts the apparatus temperature control when the CPU 81 is started. The apparatus temperature control is an example of a process that achieves a control method for the unit heater 36, the peripheral heater 52, the cooling device 51, and the drive circuit 300. The CPU 81 including the temperature control portion 8d is an example of a processor that achieves the control method.

In the following description, S101, S102, . . . are symbols that identify each of a plurality of steps in the apparatus temperature control. In the apparatus temperature control, first, the process of step S101 is executed.

When the apparatus temperature control is started, the power supply to the drive circuit 300 and the unit heater 36 in each nozzle unit 30 and the power supply to the peripheral heater 52 and the cooling device 51 are stopped.

### Step S101

In step S101, the temperature control portion 8d adjusts the power supply to the peripheral heater 52 by executing the second temperature feedback control.

After step S101, the temperature control portion 8d continues the second temperature feedback control.

The temperature control portion 8d executes the second temperature feedback control during the period from when the CPU 81 is started to when the printing request is received (step S101). Thus, each nozzle unit 30 is allowed to be heated to a degree that will not cause deterioration due to thermal load. As a result, the first printing time when the printing request occurs is shortened.

In addition, under circumstances in which each nozzle unit 30 does not consume power and each nozzle unit 30 is heated from the outside by the peripheral heater 52, cooling by the cooling device 51 is not necessary. The second temperature feedback control in step S101 is executed in a state in which the power supply to the drive circuit 300 and the unit heater 36 in each nozzle unit 30 and the power supply to the cooling device 51 are stopped. Therefore, the power consumption during the period from when the CPU 81 is started until when the printing request is received is low.

After executing the process of step S101, the temperature control portion 8d executes the process of step S102.

### Step S102

In step S102, the temperature control portion 8d waits until a printing request is received via the communication device 85 or the operation device 801. The printing request is an image formation request.

After receiving the printing request, the temperature control portion 8d executes the process of step S103.

### Step S103

In step S103, the temperature control portion 8d executes a request response process that will be described later (see FIG. 5).

The request response process is a process of outputting printing permission after adjusting the temperature of each nozzle unit 30 to a temperature at which the printing process can be performed. The printing control portion 8c executes the printing process corresponding to the printing request on condition that the printing permission is output.

After executing the process of step S103, the temperature control portion 8d executes the process of step S104.

### Step S104

In step S104, the temperature control portion 8d executes a post-permission process that will be described later. The post-permission process is a process for maintaining each of the nozzle units 30 in an appropriate state after the printing permission is output.

When the post-permission process is completed, the temperature control portion 8d ends the apparatus temperature control.

### Request Response Process

Next, an example of a procedure of the request response process performed by the temperature control portion 8d will be described with reference to the flowchart shown in FIG. 5.

In the following description, S201, S202, . . . are symbols that identify each of a plurality of steps in the request response process. In the request response process, first, the process of step S201 is executed.

### Step S201

In step S201, the temperature control portion 8d adjusts the power supply to the unit heater 36 by executing the first temperature feedback control.

The temperature control portion 8d executes the process of step S201, and then executes the process of step S202.

### Step S202

In step S202, the temperature control portion 8d waits until the first detected temperature becomes equal to or higher than a preset reference temperature. For example, the reference temperature is the first target temperature or a temperature within a target range based on the first target temperature.

When the request response process is executed, the second temperature feedback control is already being executed. Thus, the time required for the first detected temperature to reach or exceed the reference temperature is reduced.

The temperature control portion 8d executes the process of step S203 when the first detected temperature becomes equal to or higher than the reference temperature.

### Step S203

In step S203, the temperature control portion 8d outputs the printing permission to the printing control portion 8c. The printing control portion 8c executes the printing process corresponding to the printing request in response to the printing permission.

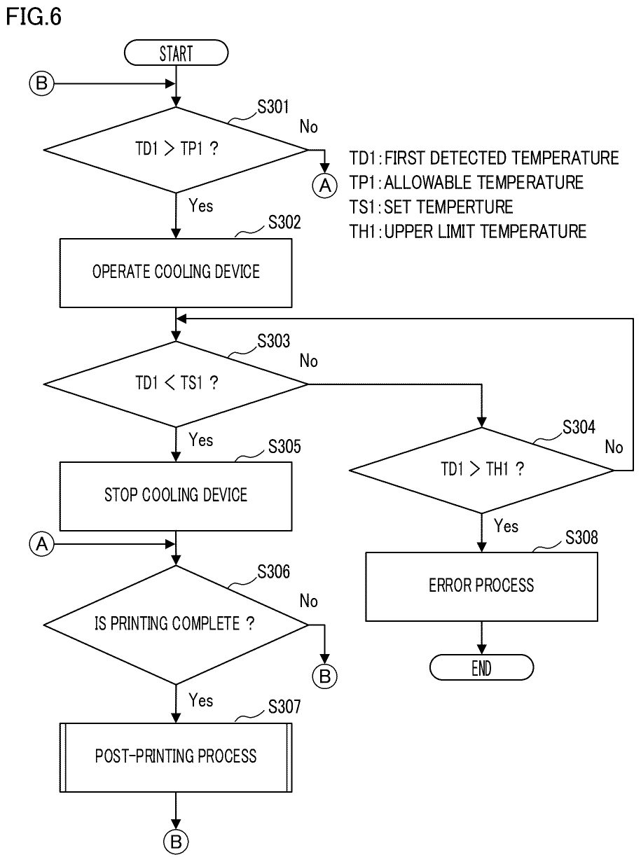

After executing the process of step S203, the temperature control portion 8d ends the request response process. Following the request response process, the temperature control portion 8d executes the post-permission process (see step S104 in FIG. 4 and FIG. 6).

### Post-Permission Process

Next, an example of a procedure of the post-permission process by the temperature control portion 8d will be described with reference to the flowchart shown in FIG. 6. The post-permission process is executed under a condition in which the first temperature feedback control is being executed.

In the following description, S301, S302, . . . are symbols that identify each of a plurality of steps in the post-permission process. In the post-permission process, step S301 is executed first.

### Step S301

In step S301, the temperature control portion 8d selects the next process depending on whether or not the first detected temperature exceeds a preset allowable temperature. The allowable temperature is higher than the first target temperature.

The allowable temperature is an upper limit of an appropriate temperature range for each nozzle unit 30 when the printing process is being performed.

The temperature control portion 8d executes the process of step S302 in a case in which the first detected temperature exceeds the allowable temperature. On the other hand, in a case in which the first detected temperature does not exceed the allowable temperature, the temperature control portion 8d executes the process of step S306.

### Step S302

In step S302, the temperature control portion 8d operates the cooling device 51. Thus, cooling of each nozzle unit 30 is executed by the cooling device 51.

After executing the process of step S302, the temperature control portion 8d executes the process of step S303.

### Step S303

In step S303, the temperature control portion 8d selects the next process depending on whether or not the first detected temperature is lower than a preset temperature.

The temperature control portion 8d executes the process of step S305 in a case in which the first detected temperature is lower than the set temperature. On the other hand, in a case in which the first detected temperature does not fall below the set temperature, the temperature control portion 8d executes the process of step S304.

### Step S304

In step S304, the temperature control portion 8d selects the next process depending on whether or not the first detected temperature exceeds a preset upper limit temperature.

The temperature control portion 8d executes the process of step S303 in a case in which the first detected temperature does not exceed the upper limit temperature. On the other hand, in a case in which the first detected temperature is higher than the upper limit temperature, the temperature control portion 8d executes the process of step S308.

That is, the temperature control portion 8d repeats the processes of steps S303 and S304 until the first detected temperature falls below the set temperature or exceeds the upper limit temperature.

### Step S305

In step S305, the temperature control portion 8d stops the operation of the cooling device 51. Furthermore, the temperature control portion 8d may stop the power supply to the cooling device 51.

After executing the process of step S305, the temperature control portion 8d executes the process of step S306.

### Step S306

In step S306, the temperature control portion 8d selects the next process depending on whether or not the printing process corresponding to the printing permission has been completed.

In a case in which the printing process is not completed, the temperature control portion 8d repeats the processes from step S301 onwards. On the other hand, when the printing process is completed, the temperature control portion 8d executes the process of step S307.

### Step S307

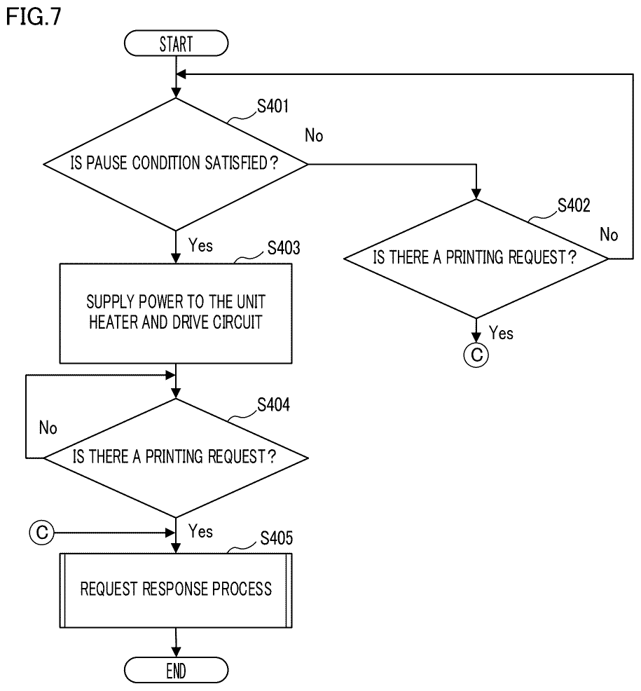

In step S307, the temperature control portion 8d executes a post-printing process that will be described later (see FIG. 7). The post-printing process is a process that is performed after the printing process is completed and before the next printing request occurs.

As will be described later, the post-printing process ends when the inkjet recording apparatus 10 receives the next printing request. When the post-printing process is completed, the temperature control portion 8d executes the processes from step S301 onward.

### Step S308

On the other hand, in step S308, the temperature control portion 8d executes error processing. The error processing includes a process of stopping the printing process, a process of stopping the power supply to the unit heater 36 and the peripheral heater 52, and a process of outputting an error message.

For example, the temperature control portion 8d outputs the error message to the display device 802 and to the host device that is the sender of the printing request. The temperature control portion 8d causes the cooling device 51 to continue operating even after executing the error process.

After executing the process of step S308, the temperature control portion 8d ends the post-permission process. This completes the apparatus temperature control.

### Post-Printing Process

Next, an example of a procedure of the post-printing process by the temperature control portion 8d will be described with reference to the flowchart shown in FIG. 7.

In the following description, S401, S402, . . . are symbols that identify each of a plurality of steps in the post-printing process. In the post-printing process, step S401 is executed first.

### Step S401

In step S401, the temperature control portion 8d selects the next process depending on whether or not the pause condition, including the fact that the printing request has not been received, are satisfied.

A first example of the pause condition is a condition that a state in which no printing request has been received continues for a preset period of time. In addition, a second example of the pause condition is a condition in which the printing request has not been received and a pause request has been received via the operation device 801 or the communication device 85.

The temperature control portion 8d executes the process of step S402 in a case in which the pause condition is not satisfied. On the other hand, in a case in which the pause condition is satisfied, the temperature control portion 8d executes the process of step S403.

### Step S402

In step S402, the temperature control portion 8d selects the next process depending on whether or not the printing request has been received.

In a case in which the printing request has not been received, the temperature control portion 8d executes the process of step S401. On the other hand, in a case in which the temperature control portion 8d receives the printing request, the temperature control portion 8d executes the process of step S408.

That is, the temperature control portion 8d repeats the processes of steps S401 and S402 until the pause condition is satisfied or until the printing request is received.

### Step S403

In step S403, the temperature control portion 8d stops the supply of power to the unit heaters 36 and the drive circuits 300 of the nozzle units 30. In step S403, the temperature control portion 8d may stop the power supply to the cooling device 51.

Hereinafter, the state in which the power supply to the unit heaters 36 and the drive circuits 300 of the nozzle units 30 is stopped will be referred to as a paused state. By executing the process of step S403, each of the nozzle units 30 is put into the paused state.

After executing the process of step S403, the temperature control portion 8d executes the process of step S404.

### Step S404

In step S404, the temperature control portion 8d waits until the printing request is received. The processes of steps S403 and S404 are executed under a condition in which each of the nozzle units 30 is in the paused state.

The temperature control portion 8d executes the process of step S405 when the printing request is received.

### Step S405

In step S405, the temperature control portion 8d executes the request response process (see FIG. 5). Thus, in a case in which the temperature control portion 8d receives the image formation request while each of the nozzle units 30 is in the paused state, the temperature control portion 8d starts the process of step S201 (see step S201 in FIG. 5).

After executing the request response process, the temperature control portion 8d ends the post-printing process.

By employing the inkjet recording apparatus 10, it is possible to reduce the power consumption of the plurality of nozzle units 30 and the cooling device 51, while shortening the first printing time.

### Modification

Next, a modification of the apparatus temperature control will be described.

The temperature control portion 8d in the present modification ends the second temperature feedback control before the first detected temperature reaches the reference temperature after the first temperature feedback control of the request response process is started.

That is, the temperature control portion 8d in the present modification stops the power supply to the peripheral heater 52 when the first temperature feedback control is being executed.

For example, the temperature control portion 8d ends the second temperature feedback control and stops the power supply to the peripheral heater 52 when the first detected temperature reaches a first set temperature. The first set temperature is lower than the reference temperature.

Furthermore, the temperature control portion 8d in the present modification restarts the second temperature feedback control after the pause condition is satisfied in the post-printing process. For example, the temperature control portion 8d restarts the second temperature feedback control when the second detected temperature falls below a preset second set temperature.

That is, the temperature control portion 8d in the present modification waits until the second detected temperature falls below the second set temperature in the paused state, and then starts adjusting the power supplied to the peripheral heater 52 by the second temperature feedback control.

Even in a case in which the present modification is adopted, the same effects as when the above embodiment is adopted can be obtained.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An inkjet recording apparatus, comprising:
a nozzle unit including a plurality of nozzles, a plurality of piezoelectric elements corresponding to the plurality of nozzles, a first heater, a first temperature sensor, and a drive circuit capable of supplying a drive signal to the plurality of piezoelectric elements, and configured to form an image on a sheet by ink ejected from the plurality of nozzles by supplying the drive signal to the plurality of piezoelectric elements;
a second heater configured to externally heat the nozzle unit;
a cooling device configured to cool the nozzle unit with a coolant;
a second temperature sensor configured to detect a temperature outside the nozzle unit; and
a control portion configured to control the first heater, the drive circuit, the second heater, and the cooling device; wherein
the control portion adjusts the power supplied to the first heater by a first temperature feedback control based on a first detected temperature detected by the first temperature sensor and a first target temperature;
the control portion further operates the cooling device when the first detected temperature exceeds an allowable temperature under a condition in which the first temperature feedback control is being executed;
the control portion further stops the supply of power to the first heater and the drive circuit when a pause condition including a state in which an image formation request is not received is satisfied under a situation in which the first temperature feedback control is being executed;
the control portion further adjusts the power supplied to the second heater by a second temperature feedback control based on a second detected temperature detected by the second temperature sensor and a second target temperature in a paused state in which power supply to the first heater and the drive circuit is stopped; and
in a case in which the control portion receives the image formation request in the paused state, the control portion further adjusts the power supplied to the first heater by the first temperature feedback control.

2. The inkjet recording apparatus according to claim 1; wherein
the control portion stops the supply of power to the cooling device when the first detected temperature falls below a preset temperature while the first temperature feedback control is being executed.

3. The inkjet recording apparatus according to claim 1; wherein
the control portion stops the supply of power to the second heater while the first temperature feedback control is being executed; and
the control portion further waits until the second detected temperature falls below a preset temperature in the paused state, and starts adjusting the power supplied to the second heater by the second temperature feedback control.
